(19) United States
(12) Patent Application Publication
(10) Pub. No.: US 2008/0253339 A1
(43) Pub. Date: Oct. 16, 2008

(54) Interconnection Device For a Radiocommunication Network

(76) Inventors: David Libault, Paris (FR); Jerome Gonzalez, Paris (FR); Eric Carreel, Meudon (FR)

Correspondence Address: Joseph J. Laks;Thomson Licensing LLC, 2 Independence Way, Patent Operations, PO Box 5312, PRINCETON, NJ, 08543, US

(21) Appl. No.: 10/593,008

(22) PCT Filed: Mar. 17, 2005
(86) PCT No.: PCT/FR2005/000658

§ 371 Date: Sep. 18, 2006

(30) Foreign Application Priority Data
Mar. 22, 2004 (FR) 0402930

(51) Int. Cl. H04Q 7/24; H04L 12/28

(52) U.S. Cl. 370/338; 370/351

(57) ABSTRACT

Local radiocommunication device comprising an IP access point adapted to communicate outwards from the network in IP mode, a point-to-point communication module adapted to communicate with a terminal according to at least one point-to-point communication protocol, and an interface adapted to allow the IP access point to communicate with the point-to-point communication module and thus to allow the said terminal to communicate with the outside of the local radiocommunication network.

The present invention relates to local radiocommunication devices.

More particularly, the invention relates to a local radiocommunication device comprising:
at least one IP point of access adapted to communicate at least outwards from the network in IP mode,
a point-to-point communication module adapted to communicate at least with a terminal according to at least one point-to-point communication protocol,
and a first interface adapted to allow the IP access point to communicate with the point-to-point communication module.

The document EP-1 343 280 describes an example of such a device.

The present invention notably has the purpose of facilitating the communication between an electronic device that communicates with the IP access point and a terminal that communicates with the point-to-point communication module.

For this purpose, according to the invention, a local radiocommunication network of the type in question is characterized in that the first interface is adapted to be presented to an electronic device communicating in IP mode with the IP access point, in the form of at least one virtual port and the said first interface is adapted to be controlled by the said electronic device by means of control instructions.

According to one embodiment, the said virtual port is a serial port.

According to a particular implementation, the said control instructions are of the “AT” type.

It will be noted that the point-to-point communication module and the interface can be physically included in a single device.

Thanks to these arrangements, the terminal can communicate easily with the IP network, for example with a locally present computer or printer, with the Internet network, etc.

Moreover, in diverse embodiments of the method according to the invention, it is possible to have recourse to one and/or other of the following arrangements:
the point-to-point communication module is adapted to communicate with the terminal by a serial radio link;
the point-to-point communication module is adapted for communicating with the terminal according to the “BLUETOOTH” protocol by using a predefined serial port profile in the said “BLUETOOTH” protocol;
the IP access point is connected to the Internet network;
the IP access point comprises an ADSL interface suitable for access to the Internet network;
the IP access point communicates with a local electronic device (particularly a computer) in IP mode;
the IP access point communicates in IP mode with the local electronic device by radio channels according to the standard IEEE 802.11 (particularly 802.11b, possibly 802.11a or g);
the IP access point communicates in IP mode with the local electronic device by a link chosen between a USB link and an Ethernet link;
the electronic device is adapted to be connected to a predetermined IP address corresponding to the said IP access point during the opening of the said virtual link, for example serial, and thus to control the said first interface by control instructions, for example but not necessarily of the “AT” type;
the first interface is adapted to be presented to the electronic device communicating with the IP access point, in the form of several virtual serial ports corresponding respectively to several terminals adapted to communicate by radio with the point-to-point communication module;
the interface is adapted to:
   indicate several terminals to an electronic device communicating with the IP access point, terminals with which the said point-to-point communication module can communicate,
   and route the communications between the electronic device and the said terminals according to commands received from the said electronic device communicating with the IP access point;
the terminals indicated by the first interface to the electronic device communicating with the IP access point, comprise predetermined terminals recognised in advance by the said first interface;
the first interface communicates in IP mode with at least one electronic device (local [printer, computer, etc.] or remote [particularly server hosting a website]) by the IP access point, this electronic device being adapted to provide at least one function, and the point-to-point communication module is adapted to be presented to the terminal as a device providing the said function (printer, computer, website, etc.);
the point-to-point communication module is adapted to be presented to the terminal as several devices providing several functions (in reality provided by one or more real devices communicating with the interface by the IP network);
the point-to-point communication module (1a) communicates with the said terminal (4, 5) according to the “BLUETOOTH” protocol and is adapted to identify itself in “BLUETOOTH” mode like the said several devices;
the point-to-point communication module is adapted to be presented to the terminal at least as a printer, and to route the data to print, received from the terminal, to a printer that communicates in IP mode with the IP access point;
the point-to-point communication module is adapted to be presented at the terminal as a port, for example a serial port, and to route a communication initiated by the terminal to an electronic device that communicates in IP mode with the IP access point;
the terminal is a personal digital assistant, the electronic device is a computer communicating locally with the IP access point, the digital assistant and the computer being adapted to mutually update predetermined files according to data contained in the said digital assistant and data contained in the said computer (“synchronisation”);
the first interface is adapted to:
   indicate, at least to the terminal, the entities (particularly an electronic device such as a computer or other, a memory directory, an IP address, etc.) with which the said terminal can communicate in IP mode by means of the said IP access point,
   and route at least some communications between the said terminal and the said entities according to commands received from the said terminal;
the first interface is adapted to route at least some communications initiated by the said terminal automatically towards a predetermined entity;
the first interface is adapted to transfer, according to the “OBEX” protocol (standard decreed by the IRDA), objects (in the software sense: notably files of digital films, digital photos, digital sound recordings, etc.) between on the one hand, an entity communicating with the IP access point, and on the other, the said terminal;
the first interface is adapted to transfer the objects of the terminal on request, between the said terminal and a predetermined storage entity (IP address, directory on a local computer communicating with the IP access point, etc.);
the first interface is adapted to transfer, on request, the objects of an electronic device communicating with the IP access point, between the said terminal and the said electronic device communicating with the IP access point;
the point-to-point communication module, the first interface and the IP access point are combined in an internet communication terminal.

Other characteristics and advantages of the invention will emerge upon reading the following description of one of its embodiments, provided as a non-restrictive example and referring to the annexed drawings.

In the drawings:

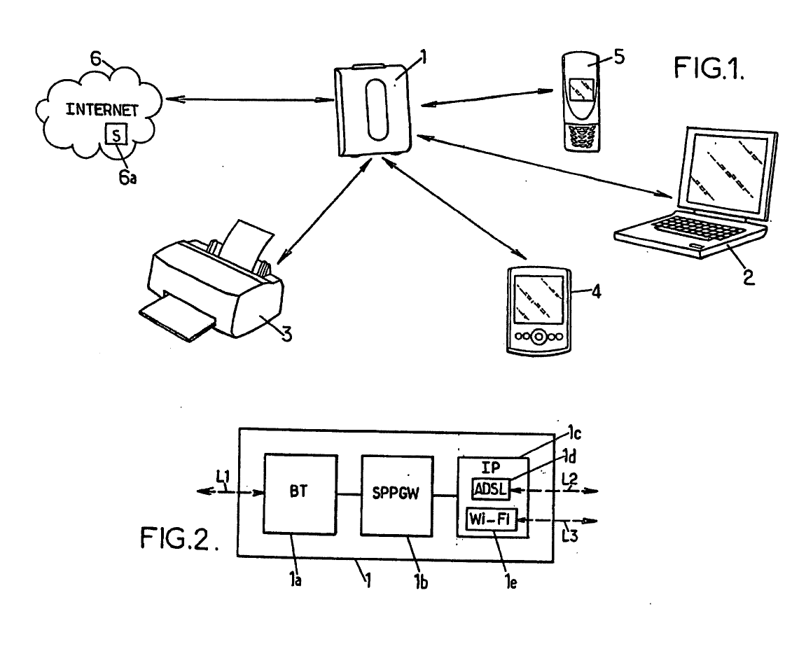

FIG. 1 is a functional diagram of a radiocommunication device according to an embodiment of the invention,

and FIG. 2 is a block diagram showing an internet connection terminal belonging to the device of FIG. 1.

In the different figures, the same references designate identical or similar elements.

As shown in FIG. 1, the invention relates to a local radiocommunication device that can comprise for example a terminal 1 adapted to communicate according to several protocols with different entities such as a computer 2, a printer 3, a personal digital assistant 4, a wireless telephone 5, the Internet network 6, etc.

The communication between the terminal 1 and some of these entities, here called terminals (for example, the digital assistant 4 and the wireless telephone 5), can be obtained through radio channels, according to a local radiocommunication standard such as the “BLUETOOTH” standard.

Advantageously, according to the invention, this communication is carried out by using a serial port profile provided for in the “BLUETOOTH” standard.

Moreover, the terminal 1 communicates in IP mode, and more exactly according to the TCP/IP mode, with the computer 2, the printer 3 and the internet network 6. For example, the computer 2 and/or the printer 3 can be linked to the terminal 1 by a radio link in accordance with the standard IEEE 802.11b, called “Wi-Fi” (or possibly according to the standard IEEE 802.11a or g).

As a variant, the communication of the terminal 1 with the computer 2 and/or the printer 3 could be carried out by an Ethernet link or by a USB link, each of these devices thus being provided with the necessary communication interfaces.

According to another variant, it would be possible to make a design such that the terminal 1 also communicates with the computer 2 and/or the printer 3 according to the same local radiocommunication protocol as the digital assistant 4 and wireless telephone 5, particularly the “BLUETOOTH” protocol, each of these devices thus being provided with the necessary communication interfaces.

Finally, in the example considered here, the terminal 1 also communicates with the Internet network, also in IP mode (TCP/IP protocol), particularly by an “ADSL” link.

As shown in greater detail in FIG. 2, the terminal 1 can comprise notably a point-to-point communication module, particularly a “BLUETOOTH” module 1a (BT) that communicates in the example considered with the digital assistant 4 and the wireless telephone 5 by means of a “BLUETOOTH” radio link L1.

Moreover, the terminal 1 also comprises a first interface 1b (SPPGW), generally constituted by a software application that enables the “BLUETOOTH” module 1a to communicate with a module 1c constituting an IP access point. This IP access point itself comprises for example an “ADSL” interface 1d that allows the “ADSL” link L2 with the Internet network, and a Wi-Fi interface 1e that allows the link L3 with the computer 2 and the printer 3 according to the IEEE protocol 802.11b.

It will be noted that the point-to-point communication module 1a, the interface 1b and the access point 1c could, if necessary, be distributed between several devices communicating between each other, rather than all be integrated into a single device such as the aforementioned terminal 1.

Owing to the interface 1b, it is possible to allow the terminals 4, 5 linked with the “BLUETOOTH” module 1a, on the one hand, and the devices 2, 3 and the Internet network 6 linked with the IP access point 1c, on the other, to communicate together.

For this purpose, the interface 1b can advantageously be adapted to inform the terminals 4, 5, of the entities with which these terminals can communicate by means of the IP access point 1c (the entities in question can be for example, besides the devices 2, 3: at least one predetermined IP address corresponding to an internet site 6a (S), a portion of a site, or even a memory directory of the computer 2, or other entity).

The entities in question can be predetermined (pre-assigned) and/or determined in real time by the IP access point 1c. When predetermined entities are involved, these entities can be recorded in advance, with all their technical characteristics, in the terminal 1; when this involves entities not known in advance but whose profile can be recognised by the access point 1c, their technical characteristics can also be recognised by the interface 1b, otherwise, the communication functions to unrecognised entities are limited to the minimum (for example to the sending of objects) with regard to the actions initiated by the terminals 4, 5.

Hence, when a communication with one of the aforementioned entities is initiated by one of the terminals 4, 5, it may be possible to select the entity with which one wishes to allow the terminal in question to communicate, for example by means of a menu displayed on the screen of the terminal in question. As a variant, it is possible to provide that a communication initiated by one of the terminals 4, 5 must occur with a given entity among those described previously, in which case the user of the terminal 4, 5 is offered no choice (notably when the terminal 4, 5 is not recognised in advance by the terminal 1).

Advantageously, the “BLUETOOTH” communication module 1a can be presented, on the “BLUETOOTH” local radio network, as several virtual entities corresponding to different functions provided by the aforementioned entities that actually communicate with the IP access point 1c (a single entity possibly capable of corresponding to several functions): for this purpose, the terminal 1 is identified on the “BLUETOOTH” network as several “BLUETOOTH” devices.

For example, the terminal 1 can thus be presented to the terminals 4, 5 both as:
a printer (with a view to allowing one of the terminals 4, 5 to communicate with the printer 3),
and as a serial port (with a view to allowing the computer 2 to communicate with one of the terminals 4, 5, particularly to “synchronise” the data between the said terminals and the computer 2, namely, to mutually update the data of a phone directory, a task directory, a diary, or other elements, from data some of which is initially comprised in one of the terminals 4, 5, and some in the computer 2).

Moreover, the interface 1b is advantageously adapted to be presented particularly at the computer 2 as constituting a virtual serial port that can be controlled by the computer 2 by means of “AT” commands. The computer 2 thus comprises a software application that simulates this virtual serial port and that is adapted to connect to a predetermined IP address corresponding to the terminal 1 during the opening of the said virtual serial link, and thus to control the terminal (the interface 1b) by the “AT” instructions.

Advantageously, when several terminals 4, 5 can communicate with the “BLUETOOTH” communication module 1a, the interface 1b is adapted to indicate these terminals to the computer 2.

The terminals in question can be predetermined, as well as their technical characteristics, in which case the terminals and the characteristics in question are stored in the terminal 1 to be communicated to the computer 2 as soon as the link between the terminal 1 and the computer 2 is established. Possibly, only the characteristics of the terminals 4, 5 which are really linked with the “BLUETOOTH” module 1a can then be communicated to the computer 2.

As a variant, it may be possible to provide that the interface 1b communicates, to the computer 2, the terminals not specified in advance and which enter into communication with the “BLUETOOTH” module 1a: in this case, if the technical characteristics of the terminals in question cannot be recognised by the interface 1b, the possibilities of communication between the terminals in question and the computer 2 can be limited to a few basic functions such as for example the sending of objects, at least in relation to actions initiated from the computer 2.

Advantageously, when several terminals 4, 5 communicate with the “BLUETOOTH” communication module 1a, the interface 1b can present itself to the computer 2 as constituting as many virtual serial ports as there are terminals 4, 5 linked with the “BLUETOOTH” communication module 1a.

Thanks to these arrangements, it is possible to initiate a communication from the computer 2 or from another electronic device communicating in IP mode with the IP access point 1c, to one or more of the terminals 4, 5 linked with the “BLUETOOTH” module 1a.

Advantageously, the interface 1b is adapted to transfer, according to the “OBEX” protocol (standard decreed by the IRDA), objects such as files of digital films, digital photos, digital sound recordings, between on the one hand, an entity communicating with the IP access point 1c, and on the other, one of the terminals 4, 5.

The device that has been described functions as follows:
from one of the terminals 4, 5, it is possible to send an object, for example of the type of those described above, to a predefined entity, for example the aforementioned website 6a, or a predefined memory directory of the computer 2, or other entity (“object pushing”),
from one of the terminals 4, 5, it is possible to be sent an object present in one of the aforementioned predefined entities (“object pulling”),
from the computer 2, it is possible to send an object to one of the terminals 4, 5, and/or if necessary to be sent an object present on one of these terminals,
from one of the terminals 4, 5, it is possible to cause a data synchronisation, in the sense defined above, with the computer 2,
and from the computer 2, it is possible to synchronise data with one of the terminals 4, 5,
from one of the terminals 4, 5, it is possible to print the data present on one of these terminals, by the printer 3.

Naturally, it would be possible to provide that the local radiocommunication device according to the invention only presents some of the characteristics described previously and only implements some of the aforementioned functionalities.

1. Local radio communication device comprising at least:
one IP point of access adapted to communicate at least outwards from the network in IP mode,
a point-to-point communication module adapted to communicate at least with a terminal according to at least one point-to-point communication protocol,
and a first interface adapted to allow the IP access point to communicate with the point-to-point communication module,
wherein the first interface is adapted to be presented to an electronic device communicating in IP mode with the IP access point, in the form of at least one virtual port and the said first interface is adapted to be controlled by the said electronic device by means of control instructions.

2. Local radiocommunication device according to claim 1, wherein the point-to-point communication module is adapted to communicate with the terminal by a serial radio link.

3. Local radiocommunication device according to claim 2, wherein the point-to-point communication module is adapted for communicating with the terminal according to the “BLUETOOTH” protocol by using a predefined serial port profile in the said “BLUETOOTH” protocol.

4. Local radiocommunication device according to claim 1, wherein the IP access point is connected to the Internet network.

5. Local radiocommunication device according to claim 4, wherein the IP access point comprises an ADSL interface suitable for access to the Internet network.

6. Local radiocommunication device according to claim 1, wherein the IP access point communicates with a local electronic device in IP mode.

7. Local radiocommunication device according to claim 6, wherein the IP access point communicates in IP mode with the local electronic device by radio channels according to the standard IEEE 802.11.

8. Local radiocommunication device according to claim 6, wherein the IP access point communicates in IP mode with the local electronic device by a link chosen between a USB link and an Ethernet link.

9. Local radiocommunication according to claim 6 comprising, moreover, the said electronic device and wherein the electronic device is adapted to be connected to a predetermined IP address corresponding to the said access point during the opening of the said virtual serial link, and thus to control the said first interface by the “AT” instructions.

10. Local radiocommunication device according to claim 6, wherein the first interface is adapted to be presented to the electronic device communicating with the IP access point, in the form of several virtual serial ports corresponding respectively to several terminals adapted to communicate by radio with the point-to-point communication module.

11. Local radiocommunication device according to claim 6, wherein the first interface is adapted to:
indicate, to an electronic device communicating with the IP access point, several terminals with which the said point-to-point communication module can communicate,
and route the communications between the electronic device and the said terminals according to commands received from the said electronic device communicating with the IP access point.

12. Local radiocommunication device according to claim 11, wherein the terminals indicated by the first interface to the electronic device communicating with the IP access point, are predetermined terminals, recognized in advance by the said interface.

13. Local radiocommunication device according to claim 6, wherein the first interface communicates in IP mode with at least one electronic device by the IP access point, this electronic device being adapted to provide at least one function, and the point-to-point communication module is adapted to be presented to the terminal as a device providing the said function (printer, computer, website, etc.).

14. Local radiocommunication device according to claim 13, wherein the point-to-point communication module is adapted to be presented to the terminal as several devices providing several functions.

15. Local radiocommunication device according to claim 14, wherein the point-to-point communication module communicates with the said terminal according to the “BLUETOOTH” protocol and is adapted to identify itself in “BLUETOOTH” mode like the said several devices.

16. Local radiocommunication device according to claim 13, wherein the point-to-point communication module is adapted to be presented to the terminal at least like a printer, and to route the data to be printed, received from the terminal to a printer that communicates in EP mode with the IP access point.

17. Local radiocommunication device according to claim 13, wherein the point-to-point communication module is adapted to be presented to the terminal at least like a serial port, and to route a communication initiated by the terminal, to an electronic device that communicates in IP mode with the IP access point.

18. Local radiocommunication device according to claim 17, wherein the terminal is a personal digital assistant, the electronic device is a computer communicating locally in IP mode with the IP access point, the digital assistant and the computer being adapted to mutually update predetermined files according to data contained in the said digital assistant and data contained in the said computer.

19. Local radiocommunication device according to claim 17, wherein the first interface is adapted to:
indicate, at least to the terminal, the entities with which the said terminal can communicate in IP mode by means of the said IP access point,
and route at least some communications between the said terminal and the said entities according to commands received from the said terminal.

20. Local radiocommunication device according to claim 17, wherein the first interface is adapted to route at least some communications initiated by the said terminal automatically towards a predetermined entity.

21. Local radiocommunication device according to claim 17, wherein the first interface is adapted to transfer, according to the “OBEX” protocol, objects between an entity communicating in IP mode with the IP access point, on the one hand, and the said terminal on the other.

22. Local radiocommunication device according to claim 17, wherein the first interface is adapted to transfer, on request, the objects of the terminal between the said terminal and a predetermined storage entity.

23. Local radiocommunication device according to claim 17, wherein the first interface is adapted to transfer, on request, the objects of an electronic device communicating in IP mode with the IP access point between the said terminal and the said electronic device communicating with the IP access point.

24. Local radiocommunication device according to claim 17, wherein the point-to-point communication module, the first interface and the IP access point are combined in an Internet communication terminal.

25. Local radiocommunication device according to claim 17, wherein the said virtual port is a serial port.

26. Local radiocommunication device according to claim 17, wherein the said control instructions are instructions of the “AT” type.
